(19) United States
(12) Patent Application Publication
(10) Pub. No.: US 2026/0011111 A1
(43) Pub. Date: Jan. 8, 2026

(54) OBJECT SEGMENTATION

(71) Applicant: Ford Global Technologies, LLC, Dearborn, MI (US)

(72) Inventors: Mayar Arafa, Redwood City, CA (US); Nikhil Nagraj Rao, Sunnyvale, CA (US); Marcos Paul Gerardo Castro, Mountainview, CA (US); Apurbaa Mallik, Sunnyvale, CA (US)

(73) Assignee: Ford Global Technologies, LLC, Dearborn, MI (US)

(21) Appl. No.: 17/460,638

(22) Filed: Aug. 30, 2021

(51) Int. Cl. G06V 10/26; B60W 10/18; B60W 10/20; B60W 50/06; G06V 10/82; G06V 20/58

(52) U.S. Cl. CPC G06V 10/26; B60W 10/18; B60W 10/20; B60W 50/06; G06V 10/82; G06V 20/58; B60W 2420/408

(57) ABSTRACT

First sensor data and second sensor data can be combined by inputting the first sensor data and second sensor data to a deep neural network. A segmentation map from the combined sensor data that includes labeled segments, wherein the labeled segments include (a) pixels corresponding to objects in the combined sensor data, (b) hazard probabilities for respective labeled segments included in the segmentation map can be determined in the deep neural network based on the combined first sensor data and the second sensor data. The segmentation map and the hazard probabilities can be output.

### BACKGROUND

Deep neural networks can be trained to perform a variety of computing tasks. For example, neural networks can be trained to extract data from images. Data extracted from images by deep neural networks can be used by computing devices to operate systems including vehicles, robots, security, product manufacturing and product tracking. Images can be acquired by sensors included in a system and processed using deep neural networks to determine data regarding objects in an environment around a system. Operation of a system can be supported by acquiring accurate and timely data regarding objects in a system's environment.

### BRIEF DESCRIPTION OF THE DRAWINGS

FIG. 1 is a block diagram of an example object detection system.

FIG. 2 is a diagram of an example image of a traffic scene.

FIG. 3 is a diagram of an example object segmentation system.

FIG. 4 is a diagram of an example deep neural network.

FIG. 5 is a diagram of another example deep neural network

FIG. 6 is a diagram of example data fusion in a deep neural network.

FIG. 7 is a diagram of another example of data fusion in a deep neural network.

FIG. 8 is a diagram of an example segmented image.

FIG. 9 is a flowchart diagram of an example process to operate a vehicle using a deep neural network.

### DETAILED DESCRIPTION

A deep neural network (DNN) can be trained to determine objects in image data acquired by sensors in systems including vehicle guidance, robot operation, security, manufacturing, and product tracking. Vehicle guidance can include operation of vehicles in autonomous or semi-autonomous modes in environments that include a plurality of objects. Robot guidance can include guiding a robot end effector, for example a gripper, to pick up a part and orient the part for assembly in an environment that includes a plurality of parts. Security systems include features where a computer acquires video data from a camera observing a secure area to provide access to authorized users and detect unauthorized entry in an environment that includes a plurality of users. In a manufacturing system, a DNN can determine the location and orientation of one or more parts in an environment that includes a plurality of parts. In a product tracking system, a deep neural network can determine a location and orientation of one or more packages in an environment that includes a plurality of packages.

Vehicle guidance will be described herein as a non-limiting example of using a DNN to detect objects, for example vehicles and pedestrians, in a traffic scene and determine trajectories and uncertainties corresponding to the trajectories. A traffic scene is an environment around a traffic infrastructure system or a vehicle that can include a portion of a roadway and objects including vehicles and pedestrians, etc. For example, a computing device in a traffic infrastructure can be programmed to acquire one or more images from one or more sensors included in the traffic infrastructure system and detect objects in the images using a DNN. The images can be acquired from a still or video camera and can include range data acquired from a range sensor including a lidar sensor. The images can also be acquired from sensors included in a vehicle. A DNN can be trained to label and locate objects and determine trajectories and uncertainties in the image data or range data. A computing device included in the traffic infrastructure system can use the trajectories and uncertainties of the detected objects to determine a vehicle path upon which to operate a vehicle in an autonomous or semi-autonomous mode. A vehicle can operate based on a vehicle path by determining commands to direct the vehicle's powertrain, braking, and steering components to operate the vehicle to travel along the path.

Vehicles operating based on a vehicle path determined by a deep neural network can benefit from detecting objects on or near the vehicle path and determining whether to continue on the vehicle path, stop, or determine a new vehicle path that avoids the object. For example, an object such as a plastic bag, cardboard box or other small, soft object can be safely driven over. In other examples, a small animal, a sharp object, or other object that could be harmed or damage the vehicle should not be driven over and the vehicle should stop or determine a new vehicle path that avoids the small animal or sharp object. Object detection and image segmentation techniques based on deep neural networks can rely on training based on manual analysis and user consensus of object labels to annotate training datasets. Datasets required to train deep neural networks can be expensive and time-consuming to compile and tend to suffer from labeling ambiguity and out of distribution problems. Label ambiguity refers to differences in opinions resulting from a plurality of users manually labeling objects in training images. Out of distribution problems refers to some types of objects not being included in training datasets. Label ambiguity and out of distribution problems make it difficult to train deep neural networks for use in the real world where input data is constantly changing and includes previously unseen types of objects.

Because the real world includes constantly changing and previously unseen types of objects, training datasets cannot be exhaustive, and a trained deep neural network will encounter objects for which the deep neural network was not trained. Presenting a deep neural network with data upon which the deep neural network was not trained for can lead to unpredictable results. Moreover, small and far away objects that are imaged as a small number of pixels in an image in adverse conditions can be difficult to reliably detect by a deep neural network. Hazy or blurry images acquired in low light caused by cloudy or rainy atmospheric conditions, including reflections caused by puddles or ice and snow can create difficulties in detecting objects, where object detection includes labeling and locating the object in an image. In other examples, water droplets, snow or ice on the lens or lens covering of a sensor can obscure small objects in the field of view of a sensor and create difficulties in detecting objects.

Techniques discussed herein improve detection of objects in the field of view of a vehicle by training a deep neural network to perform class agnostic object detection based on combining sensors such as radar, lidar, and ultrasound with image sensors. Class agnostic object detection is object detection that does not rely of labeling the detected object, but rather just estimates the size and location. For example, an environment around a vehicle, referred to herein as a traffic scene, can include objects such as vehicles, pedestrians, roadways, sidewalks, buildings, foliage, etc. Techniques discussed herein can segment an image of a traffic scene to identify regions of the image corresponding to objects without labeling the objects. In addition, techniques discussed herein estimate a probability that the detected object corresponds to a hazard that can be harmed or damage a vehicle while maintaining real time performance. Techniques discussed herein improve vehicle operation by detecting objects that have a high probability of corresponding to hazards that would not be labeled and located by trained deep neural networks.

A method is disclosed, including combining first sensor data and second sensor data by inputting the first sensor data and the second sensor data to a deep neural network, determining, in the deep neural network based on the combined first sensor data and the second sensor data, a segmentation map from the combined sensor data that includes labeled segments, wherein the labeled segments include (a) pixels corresponding to objects in the combined sensor data, (b) hazard probabilities for respective labeled segments included in the segmentation map, and outputting the segmentation map and the hazard probabilities. A vehicle can be operated based on the segmentation map and the hazard probabilities. The vehicle can be operated by controlling one or more of vehicle powertrain, vehicle brakes, and vehicle steering. The first sensor data can be image data. The image data can include red, green, and blue pixels arranged in a rectangular array of image pixels.

The first sensor data can be radar data. The radar data can include azimuth angle, distance, and radar cross-section arranged in a rectangular array of radar pixels. The radar data can include a plurality of radar scans acquired at different times and combined by compensating for motion. The deep neural network can be a convolutional neural network that includes convolutional layers, max pooling layers, and upsampling layers arranged in an hourglass configuration. The first sensor data and the second sensor data can be combined based on a camera calibration matrix. The deep neural network can be trained based on ground truth segmentation maps and ground truth hazard probabilities. The hazard probabilities can be grouped into two or more levels. The objects in the combined sensor data can include pedestrians, vehicles, roadways, buildings, and foliage. The vehicle can be operated based on determining a vehicle path based on the segmentation map and the hazard probabilities.

Further disclosed is a computer readable medium, storing program instructions for executing some or all of the above method steps. Further disclosed is a computer programmed for executing some or all of the above method steps, including a computer apparatus, programmed to combine first sensor data and second sensor data by inputting the first sensor data and the second sensor data to a deep neural network, determine, in the deep neural network based on the combined first sensor data and the second sensor data, a segmentation map from the combined sensor data that includes labeled segments, wherein the labeled segments include (a) pixels corresponding to objects in the combined sensor data, (b) hazard probabilities for respective labeled segments included in the segmentation map, and output the segmentation map and the hazard probabilities. A vehicle can be operated based on the segmentation map and the hazard probabilities. The vehicle can be operated by controlling one or more of vehicle powertrain, vehicle brakes, and vehicle steering. The first sensor data can be image data. The image data can include red, green, and blue pixels arranged in a rectangular array of image pixels.

The computer can include radar data as the first sensor data. The radar data can include azimuth angle, distance, and radar cross-section arranged in a rectangular array of radar pixels. The radar data can include a plurality of radar scans acquired at different times and combined by compensating for motion. The deep neural network can be a convolutional neural network that includes convolutional layers, max pooling layers, and upsampling layers arranged in an hourglass configuration. The first sensor data and the second sensor data can be combined based on a camera calibration matrix. The deep neural network can be trained based on ground truth segmentation maps and ground truth hazard probabilities. The hazard probabilities can be grouped into two or more levels. The objects in the combined sensor data can include pedestrians, vehicles, roadways, buildings, and foliage. The vehicle can be operated based on determining a vehicle path based on the segmentation map and the hazard probabilities.

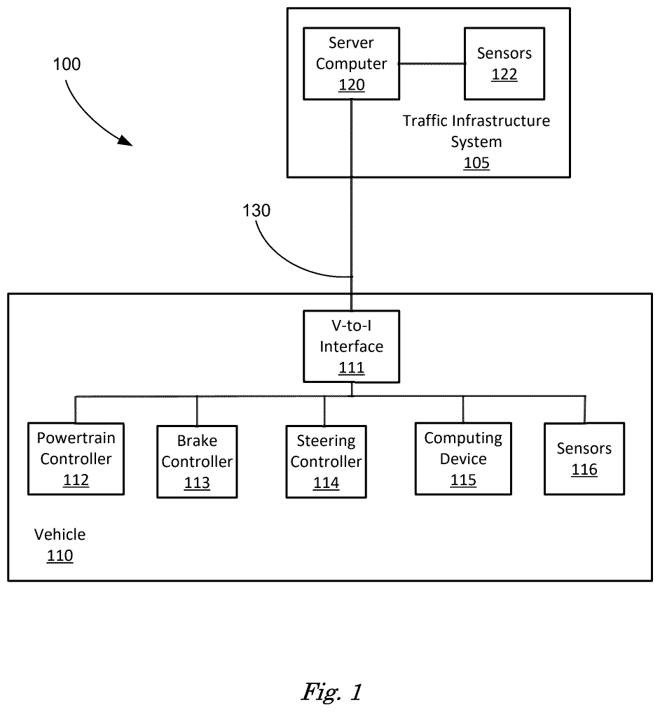

FIG. 1 is a diagram of an object detection system 100 that can include a traffic infrastructure system 105 that includes a server computer 120 and sensors 122. Object detection system 100 includes a vehicle 110, operable in autonomous (“autonomous” by itself in this disclosure means “fully autonomous”), semi-autonomous, and occupant piloted (also referred to as non-autonomous) mode. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network, e.g., including a bus in the vehicle 110 such as a controller area network (CAN) or the like; the vehicle 110 network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, includes hardware, firmware, and software that permits computing device 115 to communicate with a remote server computer 120 via a network 130 such as wireless Internet (WI-FI®) or cellular networks. V-to-I interface 111 may accordingly include processors, memory, transceivers, etc., configured to utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks, e.g., according to Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executable by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve safe and efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, e.g., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Vehicles can be equipped to operate in both autonomous and occupant piloted mode. By a semi-or fully-autonomous mode, we mean a mode of operation wherein a vehicle can be piloted partly or entirely by a computing device as part of a system having sensors and controllers. The vehicle can be occupied or unoccupied, but in either case the vehicle can be partly or completely piloted without assistance of an occupant. For purposes of this disclosure, an autonomous mode is defined as one in which each of vehicle propulsion (e.g., via a powertrain including an internal combustion engine and/or electric motor), braking, and steering are controlled by one or more vehicle computers; in a semi-autonomous mode the vehicle computer(s) control(s) one or more of vehicle propulsion, braking, and steering. In a non-autonomous mode, none of these are controlled by a computer.

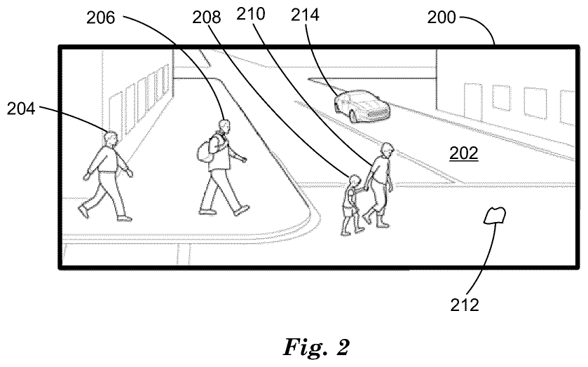

FIG. 2 is a diagram of an image of a traffic scene 200. The image of the traffic scene 200 can be acquired by a sensor 122 included in a traffic infrastructure system 105 or a sensor 116 included in a vehicle 110. The image of the traffic scene 200 includes pedestrians 202, 204, 206, 208 and a vehicle 214 on a roadway 236. Also included in traffic scene 200 is an object 212. Object 212 can be a plastic bag, paper bag, or a piece of paper, etc., being blown across the roadway 236. Object 212 is an example of an object that would be imaged by an image sensor but would not be detected by a radar sensor, for example.

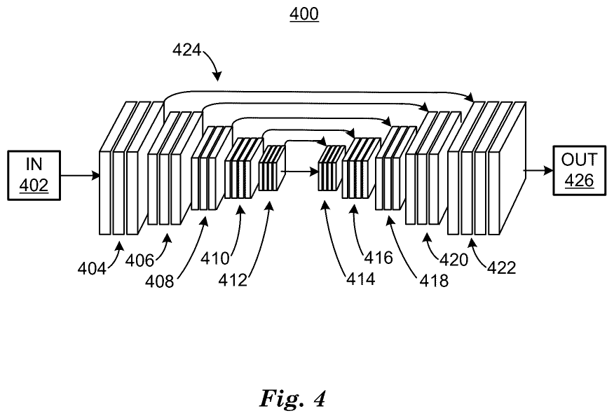

Techniques discussed herein can detect an object 212 by inputting image data and radar data to an object segmentation system 400, described in relation to FIG. 4, below. The object segmentation system 400 performs sensor fusion on the image data and radar data, segments the fused data and outputs a segmented image and hazard probabilities corresponding to the image segments. Sensor fusion is when a processing technique such as implemented in the object segmentation system 400 described herein combines two or more image modalities (i.e., kinds of image data, i.e., from two different kinds of sensors), such as a frame of video data and a frame of radar data and processes the two or more image modalities as one image. Image segmentation such as performed in an object segmentation system means determining regions of contiguous pixels in image data based on properties of the image pixels. The properties of the image pixels that can be used to segment the image include edges and pixels properties such as similarities in grayscale or color values or similarities in image textures or patterns. The hazard probabilities can be determined by comparing pixel values in a segment or region of the image in two or more modalities. Low or high hazard probabilities can be assigned to an object based on the size of the image segment and the radar cross-section.

For example, if an image segment corresponding to an image segment the size of object 212 reflects light and therefore has visibility in a frame of video data, but does not reflect radar signals, and therefore has a low radar cross-section, the object 212 is likely paper or plastic, and would not cause an irregularity if brought into contact with a vehicle. An irregularity is a change or deviation from expected parameters in the shape or appearance of a vehicle. If an image segment the size of object 212 has a medium radar cross-section, it can correspond to a living thing such as a small animal i.e., the object 212 can be harmed but the vehicle 110 would probably escape damage if contacted by the vehicle 110. If an image segment the size of object 212 has a high radar cross-section, it can correspond to a solid object such as metal or concrete and would correspond to probable damage to the vehicle 110 if contacted. Techniques discussed herein can classify a low radar cross-section object 212 as low hazard probability and medium and high radar cross-section.

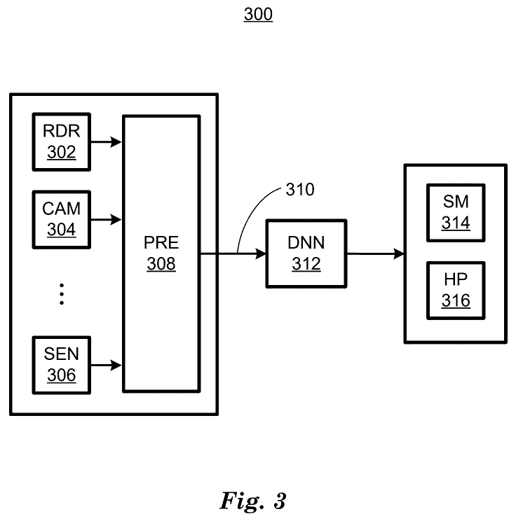

FIG. 3 is a diagram of an object segmentation system 300 based on multi-modal data. Multi-modal data is data that includes images based on two or more imaging modes, including still or video cameras, radar, lidar or ultrasound. Object segmentation system 300 can be a software program executing on computing device 115 included in a vehicle 110 that inputs data from sensors 116. Object segmentation system 300 can also be a software program executing on server computer 120 included in a traffic infrastructure system 105 that inputs data from sensors 122 included in the traffic infrastructure system 105. Object segmentation system 300 receives as radar data 302 from a radar sensor, a camera data 304 from a camera or video sensor, and, optionally, other types of sensor data 306 from sensors including lidar sensors and ultrasound sensors. Radar sensors transmit electromagnetic waves, typically at microwave frequencies, and receive and amplify the electromagnetic waves reflected from objects in the environment. The delay between transmitting and receiving the waves can indicate the distance from the transmitter to the object and the strength of the returned signal can indicate the type of material included in the object. The ability of an object to reflect radar signals is referred to as radar cross-section and is typically a function of the material included in the object, the size of the object, the size of the object relative to the radar wavelength, the angle of surfaces in the object with respect to the radar waves, and the polarization of the radar waves with respect to the object. In general, metallic materials and dense materials such as rock or concrete reflect a greater percentage of radar waves, organic materials reflect a moderate amount of radar waves and lightweight materials such as wood, paper or fiberglass can be transparent to radar waves.

Radar, camera, or other data 302, 304, 306 have differing spatial resolutions depending upon the type of sensor. Cameras, including still cameras and video cameras, typically acquire camera data 304 in rectangular arrays having hundreds of thousands or millions of pixels in closely packed arrays covering a field of view of the sensor. For example, camera data 302 can be red, green, and blue pixels arranged in a rectangular array of pixels. Camera data 304 can include grayscale, red, green, blue (RGB) color, or infrared pixels or combinations thereof, for example. Radar data 302 typically has much lower spatial resolution than camera data 304 and tend to have “dropouts” or missing data at locations that do not return sufficient radar signals to permit determination of a distance. Lidar sensors and ultrasound sensors also have lower resolution than camera data 304 and are also subject to dropouts.

Object segmentation system 300 includes a pre-processor (PRE) 308 that inputs data 302, 304, 306 from sensors and aligns the data from different sensors so that each pixel from the different types of sensors corresponds to the same location in the environment. Pre-processor 308 can also compensates for data dropouts by either labeling pixels as missing data or interpolating data from adjacent pixels. Pre-processor 308 also compensates for data from sensors that can be acquired at differing times as a vehicle 110 moves through the environment to ensure that each pixel from the different sensors corresponds to the same location in the environment. Radar data 304 is projected on the image plane using camera calibration matrix, producing a sparse 2D point cloud which includes data like the azimuth angle, the distance and the radar cross section. Pre-processor 308 can also compensate for sparsity in radar data 302 by combining radar data 302 from a plurality of radar scans acquired at different times and therefore can have differing fields of view due to vehicle 110 motion between scans. Pre-processor 308 can acquire motion data from sensors 116 included a vehicle 110 such as GPS or accelerometer-based inertial measurement units (IMUs) to determine motion of a vehicle 110 between radar scans. The motion data can be used to adjust the locations of the radar pixels from the plurality of radar scans so that each radar pixel corresponds to the same real-world location.

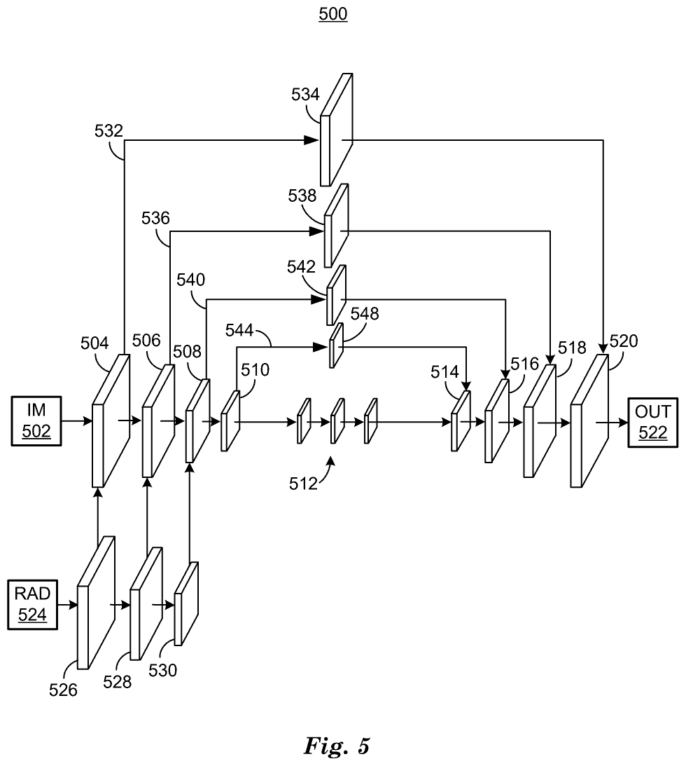

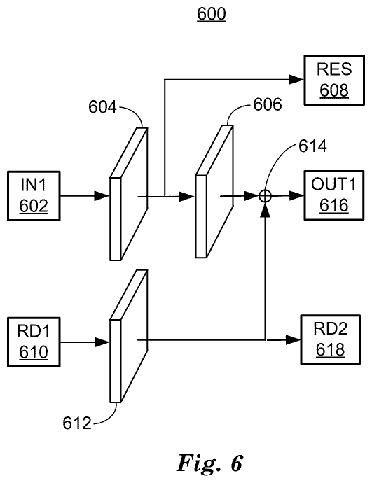

The camera image can have three channels (red, green, blue); this data is normalized and processed according to the neural network requirements. As radar data is sparse in nature, previous cycles of radar data can be optionally combined for information gain while compensating for motion. The final input to the neural network will then be the fused sparse radar image and RGB image. Pre-processor 308 outputs aligned sensor data 310 from two or more sensors to DNN 312. DNN 312 inputs the aligned data from two or more sensors, performs sensor fusion, and outputs a segmented image (SM) 314 and hazard probabilities (HP) 316 for the segments in segmented image 314. DNN 312 is discussed in relation to FIG. 4 and sensor fusion is discussed in relation to FIGS. 5 and 6.

FIG. 4 is a diagram of a deep neural network (DNN) 400. A DNN 400 can be a software program executing on a computing device 115 or a server computer 120 and can be included in an object segmentation system 300. In this example DNN 400 is a convolutional neural network (CNN). A DNN 400 can input an image (IN) 402 as input data. The image 402 is processed by encoding stages 404, 406, 408, 410, 412 and decoding stages 414, 416, 418, 420, 422 to determine an output image (OUT) 426. DNNs 400 having encoding stages 404, 406, 408, 410, 412 that down sample the input data followed by decoding stages 414, 416, 418, 420, 422 that up sample the input data are referred to an hourglass configuration. Each encoding stage 404, 406, 408, 410, 412 includes a plurality of convolutional layers followed by a pooling layer. The convolutional layers convolve the input image 402 with convolutional kernels based on weights that are determined during training of the DNN 400. Following the convolutional layers each encoding stage 404, 406, 408, 410, 412 includes a pooling layer. The pooling layer reduces the resolution of the input data by combining a neighborhood, for example a 2×2 neighborhood, of pixels into a single pixel that corresponds to the neighborhood. An example of pooling is max pooling, where the neighborhood is replaced by a single pixel corresponding to the maximum pixel value in the neighborhood. Each of the encoding stages 404, 406, 408, 410, 412 process the data to extract feature data from the input image while reducing the resolution.

Following processing by the encoding stages 404, 406, 408, 410, 412, the input data is processed by the decoding stages 414, 416, 418, 420, 422. The decoding stages 414, 416, 418, 420, 422 each include an upsampling layer followed by a plurality of convolutional layers. The upsampling layers increase the resolution of the input data by duplicating the input pixel data to determine a neighborhood of pixels to reverse the effects of the max pooling layers in encoding stages 404, 406, 408, 410, 412. Each upsampling layer inputs pooling indices 424 from a pooling layer included in an encoding stage 404, 406, 408, 410, 412 that corresponds to the resolution of the data to be output from the decoding stages 414, 416, 418, 420, 422. The pooling indices 424 guide the upsampling layers so that the upsampled data corresponds to the input data. In this example, the features determined by the encoding stages 404, 406, 408, 410, 412 are image segments and the decoding stages 414, 416, 418, 420, 422 restore the input data to the same resolution as the input image 402. The pooling indices 424 input to decoding stages 414, 416, 418, 420, 422 ensure that the segments determined by encoding stages 404, 406, 408, 410, 412 are expanded to correspond to object boundaries included in the input image 402.

Final encoding stage 422 includes a Softmax layer that determines a Softmax function of the hazard probability data, where the Softmax function scales the hazard data to occur in the interval [0,1] and thereby correspond to a probability. A Softmax function is a smooth approximation based on an argmax function. An argmax function returns the value “1” to the maximum value of a set of values, where the values are outputs corresponding to hazard probability data output from the last-except-one layer of the last encoding stage 412. Assuming the values are all non-negative, the output values are divided by the maximum value to scale the output values to the interval between 0 and 1, which permits the values to be used as probabilities.

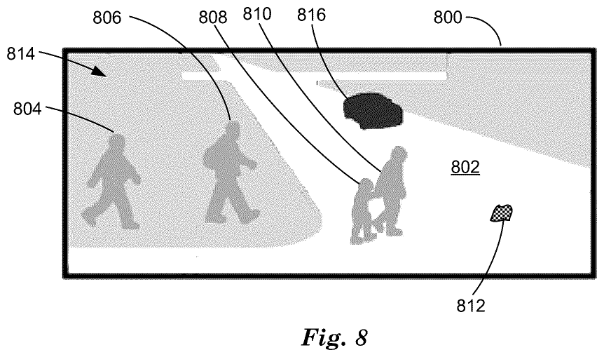

DNN 400 is trained to determine image segments by determining a training dataset of images and corresponding ground truth data. DNN 400 can be trained based on ground truth segmentation maps and ground truth hazard probabilities. Ground truth data is image data processed to include image segments corresponding to objects and regions that correspond to the results desired from processing the input image 402 with the DNN 400. Ground truth data can be determined by processing images 402 included in the training data set manually. Manual processing can include users processing images 402 using image processing software such as Photoshop to assign image pixels to segments. Photoshop is an image processing software program available from Adobe Systems, Inc. 345 Park Ave. San Jose, CA 95110. A sample segmented image 800 output by object segmentation system 300 is illustrated in FIG. 8.

A DNN 400 can be trained to segment an input image 402 by processing an input image 402 a plurality of times, each time comparing the output of the DNN 400 to ground truth data corresponding to the input image. A loss function is determined based on the difference between output of the DNN 400 and the ground truth. The loss function is backpropagated through the decoding stages 414, 416, 418, 420, 422 and encoding stages 404, 406, 408, 410, 412 and the convolutional weights are adjusted to minimize the loss function. Backpropagation is a technique for training a DNN 400 where a loss function is input to decoding stages 414, 416, 418, 420, 422 and encoding stages 404, 406, 408, 410, 412 furthest from the input and communicated from back-to-front to select weights for each layer. The ground truth data can include estimates of hazard probabilities corresponding to objects in the input image 402 data. Training of DNN 400 can include determining a hazard probability for segments included in the output 426 data.

FIG. 5 is a diagram of a DNN 500 modified to input both image (IM) 502 data and radar (RAD) 524 data, perform sensor fusion of the image 502 and radar 524 data and determine output (OUT) 522 data that includes a segmented image and hazard probabilities. Encoder stages 504, 506, 508, 510, 512 include convolutional layers and pooling layers as discussed in relation to DNN 400 in FIG. 4 above. Decoder stages 514, 516, 518, 520 include upsampling layers, convolutional layers and a Softmax layer as discussed above in relation to DNN 400 in FIG. 4, above.

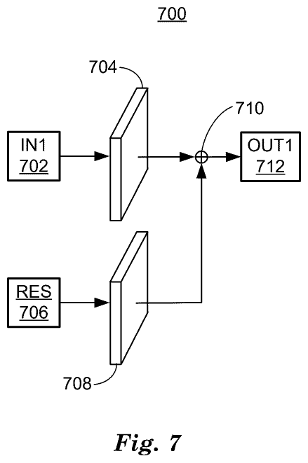

DNN 500 also includes pooling layers 526, 528, 530 that input radar 524 data and reduce the resolution of the radar 524 data so that it can be concatenated with image data at encoding stages 504, 506, 508, respectively. The combined image 502 and radar 524 data is output from the encoding stages 504, 506, 508, 510 as residual data 532, 536, 540, 544, respectively. The residual data 532, 536, 540, 544 is processed by bottleneck convolutional layers 534, 538, 542, 548. Bottleneck convolutional layers 534, 538, 542, 548 include fewer processing nodes than preceding layers to reduce the number of states included in the data. The reduced residual data is output to a decoding stage 514, 516, 518, 520 with corresponding resolution. FIGS. 6 and 7 include details on inputting radar 524 data to an encoding stage 504, 506, 508, 510 and outputting residual data 532, 536, 540, 544 to bottleneck convolutional layers 534, 538, 542, 548 and decoding stages 514, 516, 518, 520.

FIG. 6 is a diagram illustrating data fusion between image data (IN1) 602 and radar data (RD1) 610 at a single encoding stage 600 of DNN 500. Bottleneck convolutional layer 604 is the last convolutional layer of encoding stage 600. Output from bottleneck convolutional layer 604 is output as residual data 608 and output to pooling layer 606. Radar data 610 is input to radar pooling layer 612 to reduce the resolution of the radar data 610 to match the output of pooling layer 606. Image data 602 and radar data 610 is combined at combiner 614, which concatenates image data 602 pixels with radar data 610 pixels. Combined image data 602 and radar data 610 is output (OUT1) 616 to a succeeding encoding stage and reduced resolution radar data (RD2) 618 is output to a pooling layer to be combined with at a succeeding encoding stage 506, 508, 510, 512 as illustrated in FIG. 5.

FIG. 7 is a diagram illustrating data fusion between image data (IN1) 702 and residual data (RES) 706 at a single decoder stage 700 of DNN 500. Image data 702 is input to upsampling layer 704 which increased resolution of image data 702. Residual data 706 is input to bottleneck convolutional layer 708 which reduces the number of states included in residual data 706 without reducing spatial resolution. Residual data 706 and image data 702 are combined by combiner 710 which concatenates residual data 706 and image data 702 and outputs (OUT1) the combined data to a succeeding decoder stage 514, 516, 518, 520 as illustrated in FIG. 5.

FIG. 8 is a diagram of a segmented image 800 from an object segmentation system 300. Object segmentation system 300 includes hazard probabilities for each segment included in segmented image 800. Segmented image 800 includes image segments for a roadway 802, pedestrians 804, 806, 808, 810, a vehicle 816, an object 812 and background 814. Portions of segmented image 800 corresponding to roadway 802, pedestrians 804, 806, 808, 810, a vehicle 816, an object 812 and background 814 are collectively referred to as “segments” herein. Segmented mage 800 is segmented but not labeled. In segmented image 800, contiguous regions of pixels corresponding to an object are identified by a number, for example “1”, “2” and so forth. No attempt is made to label the contiguous regions as “pedestrian” or “vehicle”, etc.

While segmented image 800 does not include labels for segments 802, 804, 808, 810, 812, 814, 816, segmented image 800 does include hazard probabilities corresponding to a portion of the identified regions. For example, background 814 and roadway 802 would have zero hazard probabilities, and therefore may not include a hazard probability, because they do not pose any threat to the vehicle 110 acquiring the data. Vehicle 816 and pedestrians 804, 806, 808, 810 would have high hazard probabilities because of their radar cross-section and presence on or near the roadway. Hazard probabilities can be grouped into two or more hazard probabilities based on size, location, and radar cross-section. For example, hazard probabilities in segmented image 800 can be grouped into two or more levels corresponding to high hazard probabilities or low hazard probabilities. For example, if the hazard probability for an identified segment is less than 0.5, it can be assigned a low hazard probability and if the hazard probability is greater than 0.5 it can be assigned a high hazard probability. Hazard probability for a segment can be based on the location (i.e., in the roadway or not in the roadway), size, and radar cross-section. For example, based on the location and size of object 812, if object 812 had a medium or high radar cross-section it would likely be assigned a high hazard probability. If object 812 had a low radar cross-section it likely be assigned a low a low hazard probability.

Upon receipt of a segmented image 800 and hazard probabilities for the segments 802, 804, 808, 810, 812, 814, 816, a computing device 115 or server computer 120 can determine a vehicle path for vehicle 110. A vehicle path is a polynomial function that can be determined to avoid contact with image segments having high hazard probabilities while maintaining upper and lower limits on lateral and longitudinal accelerations of the vehicle 110. A computing device 115 can operate the vehicle 110 by transmitting commands to controllers 112, 113, 114 to control vehicle powertrain, vehicle steering, and vehicle brakes to cause vehicle 110 to operate along the vehicle path.

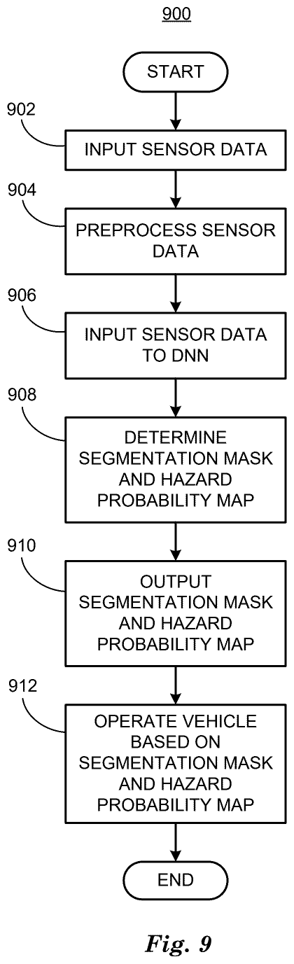

FIG. 9 is a diagram of a flowchart, described in relation to FIGS. 1-8, of a process for image segmentation and hazard probability determination based on an object segmentation system 300. Process 900 can be implemented by a processor of a computing device 115 or server computer 120, taking as input information from sensors, and executing commands, and outputting segmented images and hazard probabilities. Process 900 includes multiple blocks that can be executed in the illustrated order. Process 900 could alternatively or additionally include fewer blocks or can include the blocks executed in different orders.

Process 900 begins at block 902, where images acquired by sensors 116, 122 included in a traffic infrastructure system 105 or a vehicle 110 are input to an object segmentation system 300 as described in relation to FIG. 3 to segment images and determine hazard probabilities based on multi-modal data. The multi-modal data include two or more image modes, including image data and one or more of radar, lidar, and ultrasound.

At block 904 process 900 pre-processes the input two or more image modes to align the data to ensure that pixels of each image correspond to the same locations in the real world. Images from different modes can have different resolutions and be acquired at different times, therefore requiring processing to align the pixels of one modality with pixels of the other modality as discussed above with relation to FIG. 3.

At block 906 process 900 inputs the two or more image modalities to a DNN 500 in an hourglass configuration modified to accept multiple modalities of image data as discussed above in relation to FIGS. 5, 6, and 7.

At block 908 process 900 outputs a segmented image 800 and hazard probabilities as discussed in relation to FIG. 8, above to a computing device 115 included in a vehicle 110.

At block 910 a computing device 115 in a vehicle 110 determines a vehicle path upon which to operate vehicle 110. The vehicle path can also be determined by a server computer 120 in traffic infrastructure system 105. Upon receipt of the vehicle path, computing device 115 in vehicle 110 can determine commands to transmit to controllers 112, 113, 114 to control vehicle powertrain, steering, and brakes to operate vehicle 110 along the determined vehicle path. In examples where the object segmentation system 300 is included in a robot control system, the segmentation and hazard probabilities can be used to determine a motion path for a robot arm that avoids contacting objects in the field of view of sensors included in the robot control system. In examples where the object segmentation system 300 is included in a manufacturing system, the segmentation and hazard probabilities can be used to determine whether a foreign object has entered the workspace of a machine and could cause a problem with assembling a component. In a security system, the segmentation and hazard probabilities can be used to determine whether an object in the field of view of the sensors can be ignored, for example. Following block 910 process 900 ends.

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A computer, comprising:
a processor; and
a memory, the memory including instructions executable by the processor to:
combine first sensor data and second sensor data by inputting the first sensor data and the second sensor data to a deep neural network;
determine, in the deep neural network based on the combined first sensor data and the second sensor data, a segmentation map from the combined sensor data that includes labeled segments, wherein the labeled segments include (a) pixels corresponding to objects in the combined sensor data, (b) hazard probabilities for respective labeled segments included in the segmentation map; and
output the segmentation map and the hazard probabilities.

2. The computer of claim 1, the instructions including further instructions to operate a vehicle based on the segmentation map and the hazard probabilities.

3. The computer of claim 2, the instructions including further instructions to operate the vehicle by controlling one or more of vehicle powertrain, vehicle brakes, and vehicle steering.

4. The computer of claim 1, wherein the first sensor data is image data.

5. The computer of claim 4, wherein the image data includes red, green, and blue pixels arranged in a rectangular array of image pixels.

6. The computer of claim 1, wherein the first sensor data is radar data.

7. The computer of claim 6, wherein the radar data includes azimuth angle, distance, and radar cross-section arranged in a rectangular array of radar pixels.

8. The computer of claim 6, wherein the radar data includes a plurality of radar scans acquired at different times and combined by compensating for motion.

9. The computer of claim 1, wherein the deep neural network is a convolutional neural network that includes convolutional layers, max pooling layers, and upsampling layers arranged in an hourglass configuration.

10. The computer of claim 1, wherein the first sensor data and the second sensor data are combined based on a camera calibration matrix.

11. The computer of claim 1, wherein the deep neural network is trained based on ground truth segmentation maps and ground truth hazard probabilities.

12. The computer of claim 1, wherein the hazard probabilities are grouped into two or more levels.

13. The computer of claim 1, wherein the objects in the combined sensor data include pedestrians, vehicles, roadways, buildings, and foliage.

14. A method, comprising:
combining first sensor data and second sensor data by inputting the first sensor data and the second sensor data to a deep neural network;
determining, in the deep neural network based on the combined first sensor data and the second sensor data, a segmentation map from the combined sensor data that includes labeled segments, wherein the labeled segments include (a) pixels corresponding to objects in the combined sensor data, (b) hazard probabilities for respective labeled segments included in the segmentation map; and
outputting the segmentation map and the hazard probabilities.

15. The method of claim 14, further comprising operating a vehicle based on the segmentation map and the hazard probabilities.

16. The method of claim 15, further comprising operating the vehicle by controlling one or more of vehicle powertrain, vehicle brakes, and vehicle steering.

17. The method of claim 14, wherein the first sensor data is image data.

18. The method of claim 17, wherein the image data includes red, green, and blue pixels arranged in a rectangular array of image pixels.

19. The method of claim 14, wherein the first sensor data is radar data.

20. The method of claim 19, wherein the radar data includes azimuth angle, distance, and radar cross-section arranged in a rectangular array of radar pixels.
